(19) United States
(12) Patent Application Publication
(10) Pub. No.: US 2008/0126332 A1
(43) Pub. Date: May 29, 2008

(54) SEARCH ENGINE RANKING SYSTEM

(76) Inventor: Robert W. Nelson, Ramona, CA (US)

Correspondence Address: Frank G. Morkunas, Ste. 203, 7750 Dagget St., San Diego, CA, 92111, US

(21) Appl. No.: 11/563,357

(22) Filed: Nov. 27, 2006

(51) Int. Cl. G06F 17/30

(52) U.S. Cl. 707/5; 707/E17.108

(57) ABSTRACT

A ranking system and method for a search engine in which a ratio [X] is established between the total number of units a party is offering at a discount [NOD] and the total number of units being offered [NOU] and combining X with a ratio [Y] as established between the total amount being discounted [TDA] and the total cost of all units offered [TCA] to thereby establish a search-engine ranking [SER] which is directly proportional to the quality and quantity of discount offered. A standard pre-determined value factor may be applied to the SER for each party for easy of comparison.

### CROSS REFERENCES TO RELATED APPLICATIONS

None.

### STATEMENT REGARDING FEDERALLY-SPONSORED RESEARCH OR DEVELOPMENT

Not applicable.

### BACKGROUND

The system of this disclosure relates to an improvement in advertising and more particularly to a system whereby the interested party [advertiser, seller, or lessor as an example], by offering greater and more discounts is placed higher on a search engine ranking order.

The express purpose of this search engine ranking [SER] system is to encourage discounts to be offered by the interested party, be that party an advertiser or seller or lessor of goods or services [goods or services, whether being sold outright or rented, referred to herein as unit or units], to as many units as possible. By this system, the greater dollar amount of discount, the higher the SER for that interested party and the more likely to be seen by an end user and acted upon with a purchase or rental agreement.

By this system also, the greater dollar amount of discount compared to other like, or dislike, units [product or service] in a particular market for the same amount of time, the higher the SER for that unit to the end user thereby making it more likely that the unit will be seen by the end user and acted upon by a purchase or lease in favor of the interested party.

Additionally, the more units being discounted by the interested party as compared to that interested party's total number of units combined or available, the higher the SER. This system also levels the playing field for all interested parties regardless of how large or small that party is; i.e., whether the interested party has thousands of units or only one. Number of units does not affect the ranking, quality of discounts does; i.e., how many units are being discounted and by how much and for how long.

This system is completely opposite of what current sellers, lessors, and advertisers do, particularly the advertiser. The greater number of ads and size of ad, the more likely it will be that the advertiser will offer a discount in price of the ads to the interested party; i.e., seller and lessor. The system of this disclosure does not envision charging for advertising, though it may, but rather it encourages discounting prices to as many units as possible. With a higher SER, the interested party will be placed in a position where that party's goods or services are more apt to be seen by an end user [i.e., purchaser or lessee (also referred to as renter)] and, consequently, purchased or leased by the end user.

The foregoing has outlined some of the more pertinent objects of the search engine ranking [SER] of this disclosure. These objects should be construed to be merely illustrative of some of the more prominent features and applications of the search engine ranking [SER] of this disclosure. Many other beneficial results can be attained by applying the disclosed search engine ranking [SER] of this disclosure in a different manner or by modifying the search engine ranking [SER] of this disclosure within the scope of the disclosure. Accordingly, other objects and a fuller understanding of the search engine ranking [SER] of this disclosure may be had by referring to the summary of the search engine ranking [SER] of this disclosure and the detailed description of the preferred embodiment in addition to the scope of the search engine ranking [SER] of this disclosure defined by the claims taken in conjunction with the accompanying drawings.

### SUMMARY

The above-noted problems, among others, are overcome by the search engine ranking [SER] of this disclosure. Briefly stated, the search engine ranking [SER] of this disclosure contemplates a search-engine ranking system having a data input means for receiving data from an interested party wherein the data includes that party's (1) total number of units combined (NOU) which are being offered and, of that total number, (2) the total number of units being discounted (NOD), (3) the total combined costs for the total number of units combined (NOU) defining a total combined cost amount (TCA), and (4) the total combined discount amounts for all of discounted units (NOD) defining a total combined discount amount (TDA).

The system includes a data storage means for storing the above data received from each one of any and all interested parties and identifying the respective data unique to each one of them. The system has a data processing means for processing the data to yield a search-engine ranking (SER) unique to each one of parties and for providing the search-engine ranking (SER) in a pre-determined order to an end user pursuant to a request from that end user.

The system establishing a ranking by combining a first component (X), a ratio between a respective party's total number of discounted units (NOD) and total number of units combined (NOU), with a second component (Y), a ratio between the total combined discount amount (TDA) of the respective party and the total combined cost amount (TCA) of that party. To this search-engine ranking (SER, a value factor may be applied for ease of comprehension by a reviewer/user and comparison by that user with and among other party's rankings.

Where the duration of discount (DOD) for a party's total units discounted (NOD) varies, a duration of discount (DOD) factor is applied. The longest duration of the discount for the discounted units (NOD) defines a standard base factor (BF) which is applied to each one of said total number of discounted units (NOD) and a relative discount amount (RDA) is established as a product from a ratio between the duration of discount (DOD) and the base factor (BF) as applied to the total combined discount amount (TDA). The relative discount amount (RDA) is then utilized as an element to component Y above rather than the total combined discount amount (TDA).

The same method may be used to establish a relative cost amount (RCA) using the standard base factor (BF) for the total combined cost amount (TCA) and establishing the relative cost amount (RCA) as a quotient from a ratio between the duration of discount (DOD) and base factor (BF) as applied to the total combined cost amount (TCA). In this method, the relative cost amount (RCA) is then utilized as an element to component Y above rather than the total combined cost amount (TCA).

The foregoing has outlined the more pertinent and important features of the search engine ranking [SER] of this disclosure in order that the detailed description that follows may be better understood so the present contributions to the art may be more fully appreciated. Additional features of the search engine ranking [SER] of this disclosure will be described hereinafter which form the subject of the claims. It should be appreciated by those skilled in the art that the conception and the disclosed specific embodiment may be readily utilized as a basis for modifying or designing other structures and methods for carrying out the same purposes of the search engine ranking [SER] of this disclosure. It also should be realized by those skilled in the art that such equivalent constructions and methods do not depart from the spirit and scope of the search engine ranking [SER] of this disclosure as set forth in the appended claims.

### BRIEF DESCRIPTION OF THE DRAWINGS

For a fuller understanding of the nature and objects of the search engine ranking [SER] of this disclosure, reference should be had to the following detailed description taken in conjunction with the accompanying drawings in which:

FIG. 1 is a flow chart depicting how the system functions.

FIG. 2 is a block diagram depicting the components of the system and their interrelation to each other.

FIG. 3 is a chart illustrating the interrelation of the components and the search engine ranking system.

### DETAILED DESCRIPTION

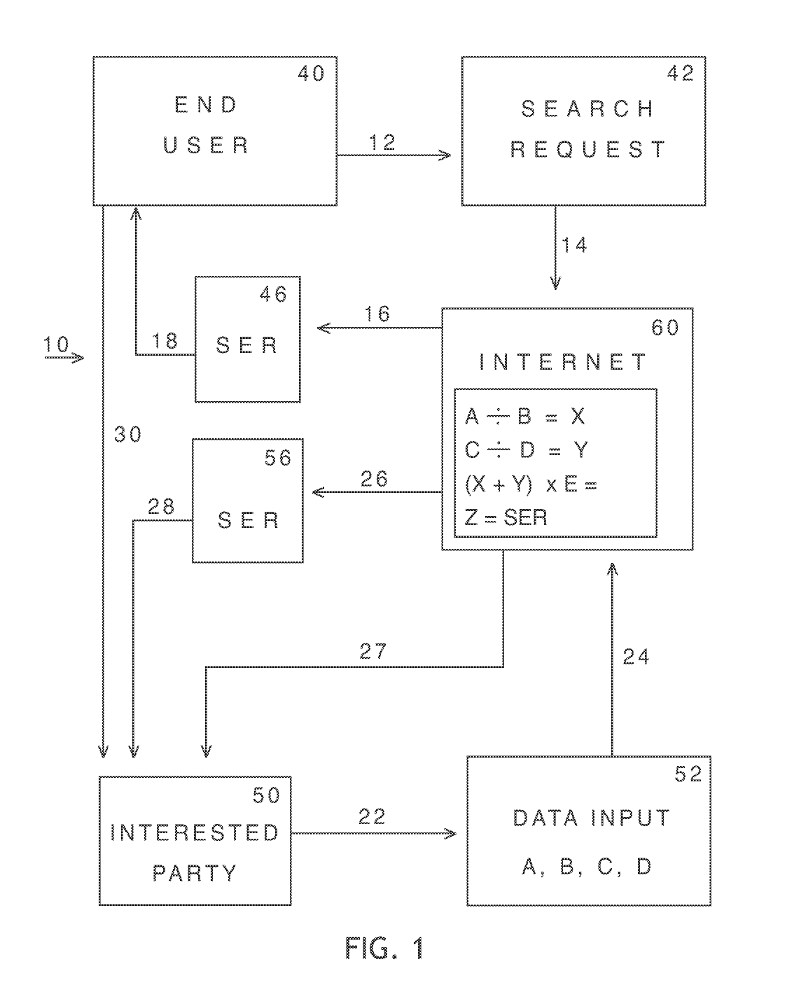

Referring now to the drawings in detail and in particular to FIG. 1, reference character 10 generally designates the searching and ranking system of how an end user 40 seeks information on a particular unit for the purpose of purchasing or renting that or similar unit. The system 10 contemplates conventional internet use 60 wherein a search request 12, 42, with designated criteria of the end user 40, is made via the internet 14, 60 and the results complied with a search engine ranking [SER] 16, 46 based on the end user's criteria and transmitted 18 and displayed to the end user 40.

Prior to such a request by an end user 40, an interested party 50 would have entered data 22, 52 at or on a web site on the internet. Generally such is a typical advertisement and offer for sale, rent, or lease, depending on the unit involved. Many internet sites offer such advertisements for no charge. These, however, are basic advertisements. For additional costs, most internet sites will offer greater exposures, more space, more graphics, and the like. With certain other features and costs, a higher ranking and placement on the search results will also be offered and/or included. The higher the ranking, the more likely the advertisement will be seen by an end user 40 and result in a consummated transaction satisfactory to the interested party 50.

If the end user 40 finds what the end user 40 likes, the end user 40 will contact 30 the interested party 50 and make appropriate arrangements to consummate the transaction; i.e., purchase, rent, or lease of the unit or units desired. The system described above of entering an end user's 40 criteria via the internet 60 and receiving results ranked in some fashion is clearly not novel. What is novel in the system of the present disclosure is how the ranking is determined.

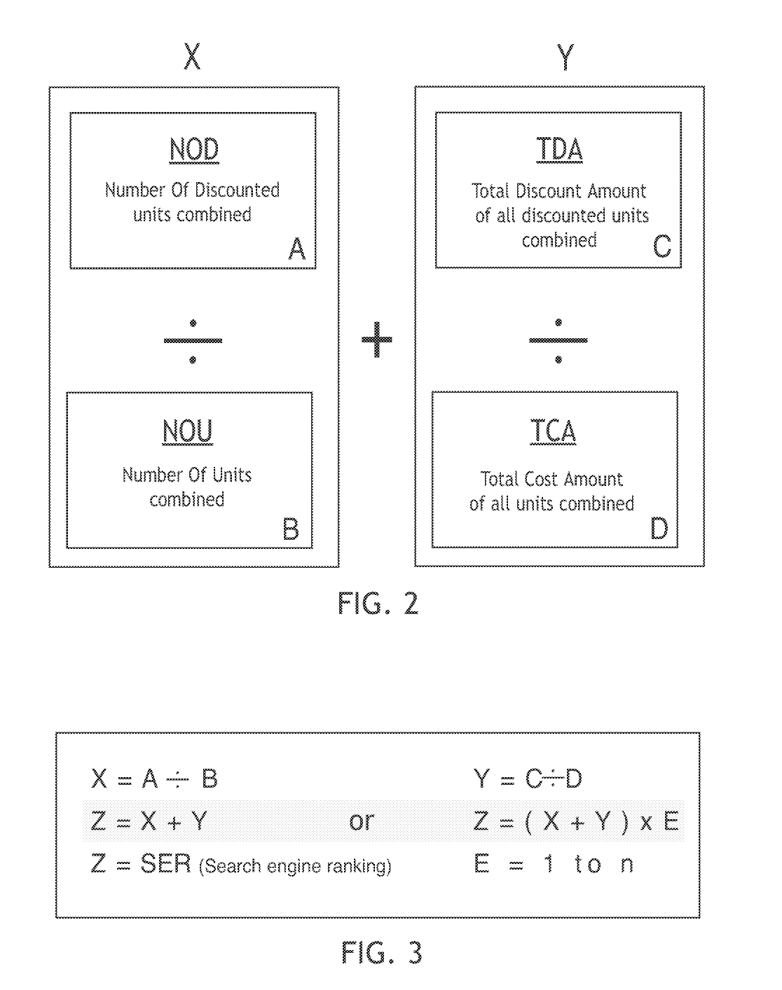

The interested party 50 will input data 22, 52 into a web site utilizing the system of the present disclosure. Referring also to FIG. 2, the interested party 50 will be requested to input that party's total number of units for which the interested party 50 desires to give discounts [referred to as NOD or alternatively as component A]. The interested party 50 will be requested to input all of the units the interested party 50 has in his inventory [referred to as NOD or alternatively as component as B].

Of that party's total number of discounted units [NOD], the interested party 50 will be requested to input the total combined dollar amount of all discounts being offered for all the discounted units combined [referred to as TDA or alternatively as C]. Of that party's total number of all units [NOU], the interested party 50 will also be requested to input the total combined, un-discounted and discounted, dollar amount for all units [referred to as TCA or alternatively as D].

After all such data is entered, the search ranking process begins yielding a search engine ranking [SER] which, when queried by an end user 40, will reveal the results 16, 46, 18 and will also reveal such results 26, 56, 28 to the interested party 50 if and as desired. Such revelation to the interested party 50, if disappointing, may be altered by the interested party 50 if the interested party 50 re-visits the site and modifies the discounts by offering greater discounts for any one or more units.

FIG. 3 illustrates the operation of the system of the present disclosure. Below are provided some examples of how the system functions to increase the SER, and thereby exposure, based on the total number of discounted units being offered by the interested party [NOD] and the total combined discount amount of all the above discounted units being offered [TDA] in relation to the total number of all the units the interested party has [NOU] and the total combined costs for the units the interested party has [TCA].

A value factor, referred to in the figures a reference character E, is a standard pre-determined value to be applied to X+Y to generate a final search engine result [SER] of a more easily readable or understandable value. The value factor may be a multiplier of 10, 100, 1,000 or any other value provided the value used remains constant so as to provide standardized results which may be easily compared against one another in meaningful fashion. As used in the examples below, and not by means of limitation, the value factor for E is 10 and 100.

### Interested Party 1:

Total number of units combined [NOU]=08 [B]
Unit 1 monthly cost=$1,000
Unit 2 monthly cost=$1,200
Unit 3 monthly cost=$1,300
Unit 4 monthly cost=$1,400
Unit 5 monthly cost=$1,500
Unit 6 monthly cost=$1,600
Unit 7 monthly cost=$1,700
Unit 8 monthly cost=$1,800

Total amount of all monthly costs [TCA]=$11,500 [D]

Number of discounted units combined [NOD]=04 [A]
Unit 1 discount=05%=$50
Unit 2 discount=05%=$60
Unit 3 discount=10%=$130
Unit 4 discount=10%=$140
Unit 5 not discounted=-0-
Unit 6 not discounted=-0-
Unit 7 not discounted=-0-
Unit 8 not discounted=-0-

Total discount amount of all discounted units combined [TDA]=$380 [C]

Therefore:
A÷B=0.500=X
C÷D=0.033=Y
X+Y=0.533=Z=SER
(X+Y)×E [where E=100]=53.3=SER
(X+Y)×E [where E=10]=5.33=SER

### Interested Party 2:

Total number of units combined [NOU]=06 [B]
Unit 1 monthly cost=$1,000
Unit 2 monthly cost=$1,200
Unit 3 monthly cost=$1,300
Unit 4 monthly cost=$1,400
Unit 5 monthly cost=$1,500
Unit 6 monthly cost=$1,600

Total amount of all monthly costs [TCA]=$8,000 [D]

Number of discounted units combined [NOD]=04 [A]
Unit 1 discount=05%=$50
Unit 2 discount=05%=$60
Unit 3 discount=10%=$130
Unit 4 discount=10%=$140
Unit 5 not discounted=-0-
Unit 6 not discounted=-0-

Total discount amount of all discounted units combined [TDA]=$380 [C]

Therefore:
A÷B=0.667=X
C÷D=0.048=Y
X+Y=0.715=Z=SER
(X+Y)×E [where E=100]=71.5=SER
(X+Y)×E [where E=10]=7.15=SER

### Interested Party 3:

Total number of units combined [NOU]=04 [B]
Unit 1 monthly cost=$1,000
Unit 2 monthly cost=$1,200
Unit 3 monthly cost=$1,300
Unit 4 monthly cost=$1,400

Total amount of all monthly costs [TCA]=$4,900 [D]

Number of discounted units combined [NOD]=04 [A]
Unit 1 discount=05%=$50
Unit 2 discount=05%=$60
Unit 3 discount=10%=$130
Unit 4 discount=10%=$140

Total discount amount of all discounted units combined [TDA]=$380 [C]

Therefore:
A÷B=1.000=X
C÷D=0.078=Y
X+Y=1.078=Z=SER
(X+Y)×E [where E=100]=107.8=SER
(X+Y)×E [where E=10]=10.78=SER

### Interested Party 4:

Total number of units combined [NOU]=01 [B]
Unit 1 monthly cost=$1,000

Total amount of all monthly costs [TCA]=$1,000 [D]

Number of discounted units combined [NOD]=01 [A]
Unit 1 discount=20%=$200

Total discount amount of all discounted units combined [TDA]=$200 [C]

Therefore:
A÷B=1.000=X
C÷D=0.200=Y
X+Y=1.200=Z=SER
(X+Y)×E [where E=100]=120.0=SER
(X+Y)×E [where E=10]=12.00=SER

### Interested Party 5:

Total number of units combined [NOU]=08 [B]
Unit 1 monthly cost=$1,000
Unit 2 monthly cost=$1,200
Unit 3 monthly cost=$1,300
Unit 4 monthly cost=$1,400
Unit 5 monthly cost=$1,500
Unit 6 monthly cost=$1,600
Unit 7 monthly cost=$1,700
Unit 8 monthly cost=$1,800

Total amount of all monthly costs [TCA]=$11,500 [D]

Number of discounted units combined [NOD]=08 [A]
Unit 1 discount=05%=$50
Unit 2 discount=05%=$60
Unit 3 discount=10%=$130
Unit 4 discount=10%=$140
Unit 5 discount=10%=$150
Unit 6 discount=10%=$160
Unit 7 discount=10%=$170
Unit 8 discount=10%=$180

Total discount amount of all discounted units combined [TDA]=$1,040 [C]

Therefore:
A÷B=1.000=X
C÷D=0.090=Y
X+Y=1.090=Z=SER
(X+Y)×E [where E=100]=109.0=SER
(X+Y)×E [where E=10]=10.90=SER

### Interested Party 6:

Total number of units combined [NOU]=08 [B]
Unit 1 monthly cost=$1,000
Unit 2 monthly cost=$1,200
Unit 3 monthly cost=$1,300
Unit 4 monthly cost=$1,400
Unit 5 monthly cost=$1,500
Unit 6 monthly cost=$1,600
Unit 7 monthly cost=$1,700
Unit 8 monthly cost=$1,800

Total amount of all monthly costs [TCA]=$11,500 [D]

Number of discounted units combined [NOD]=08 [A]
Unit 1 discount=10%=$100
Unit 2 discount=10%=$120
Unit 3 discount=10%=$130
Unit 4 discount=10%=$140
Unit 5 discount=10%=$150
Unit 6 discount=10%=$160
Unit 7 discount=10%=$170
Unit 8 discount=10%=$180

Total discount amount of all discounted units combined [TDA]=$1,150 [C]

Therefore:
A÷B=1.000=X
C÷D=0.100=Y
X+Y=1.100=Z=SER
(X+Y)×E [where E=100]=110.0=SER
(X+Y)×E [where E=10]=11.00=SER

### Interested Party 7:

Total number of units combined [NOU]=06 [B]
Unit 1 monthly cost=$1,000
Unit 2 monthly cost=$1,200
Unit 3 monthly cost=$1,300
Unit 4 monthly cost=$1,400
Unit 5 monthly cost=$1,500
Unit 6 monthly cost=$1,600

Total amount of all monthly costs [TCA]=$8,000 [D]

Number of discounted units combined [NOD]=06 [A]
Unit 1 discount=10%=$100
Unit 2 discount=10%=$120
Unit 3 discount=10%=$130
Unit 4 discount=10%=$140
Unit 5 discount=10%=$150
Unit 6 discount=10%=$160

Total discount amount of all discounted units combined [TDA]=$800 [C]

Therefore:
A÷B=1.000=X
C÷D=0.100=Y
X+Y=1.100=Z=SER
(X+Y)×E [where E=100]=110.0=SER
(X+Y)×E [where E=10]=11.00=SER

### Interested Party 8:

Total number of units combined [NOU]=02 [B]
Unit 1 monthly cost=$1,000
Unit 2 monthly cost=$1,200

Total amount of all monthly costs [TCA]=$2,200 [D]

Number of discounted units combined [NOD]=02 [A]
Unit 1 discount=20%=$200
Unit 2 discount=20%=$240

Total discount amount of all discounted units combined [TDA]=$440 [C]

Therefore:
A÷B=1.000=X
C÷D=0.200=Y
X+Y=1.200=Z=SER
(X+Y)×E [where E=100]=120.0=SER
(X+Y)×E [where E=10]=12.00=SER

In the examples above, those with the higher SER will be revealed and listed above all those with a lower SER. Naturally, the higher the ranking [listing] the more likely to be seen by the end user 40.

These examples above relate to rental units, such as, but not limited to, residential rentals and commercial rentals, based on monthly rental amounts. The system may be used on the rental of any type of product or space [referred to as a unit] and on the sale of any type of goods [referred to as a unit] based on total number of goods/units combined [NOU], total number of discounted goods/units combined [NOD], the total discount amount of all discounted goods/units combined [TDA], and the total cost amount of all the goods/units combined [TCA].

The system may also be used for weekly rentals, monthly rentals [as in the example], yearly rentals, and any combinations thereof. For rentals, all like rentals may be, but need not be, grouped together; i.e., all monthly rentals are grouped with other monthly rentals of the same duration and all yearly rentals are grouped only with other yearly rentals of the same duration.

Where like rentals are not grouped together but are grouped with groups of differing durations, Duration Of Discount [DOD] becomes a standardizing factor to establish relative values for Total Discount Amount [TDA] which, when established is the Relative Discount Amount [RDA] and may function in lieu of the TDA. Or DOD may be used to establish relative values for Total Cost Amount [TCA] which, when established is the Relative Cost Amount [RCA] and may function in lieu of the TCA.

Standardization is fundamental for establishing meaningful search engine rankings [SER]. The Relative Discount Amount [RDA] and the Relative Cost Amount [RCA] are established by using a suitable Base Factor [BF] and once established, as stated above, either one may be used in the overall ranking-establishment process. For units which are residential or commercial rentals, a one-year period [12 months] with 12 being the Base Factor [BF].

For the system application, DOD cannot be a value of zero [“0”] even in those instances where DOD in reality is 0; i.e., where a landlord in a housing rental situation for example does not offer any discount for any period of time. In such cases, DOD is any value greater than “0” or less than “0”; i.e., a negative value. Whatever value chosen, however, should be, as is for the Base Factor [BF] described above, a standard value applied equally to all throughout the system application.

In an example below, the value one [“1”] is used for illustration purposes and not by means of limitation and the search engine ranking [SER] is established with DOD as 1 in relation to the established Base Factor [BF] for this purpose. For this purpose, however, the value “1” is the preferred value.

In instances where RDA functions in lieu of TDA, an RDA for each unit of an interested party must be established then all RDAs so established of that party are used in lieu of the TDA illustrated in FIG. 2. For example, if the interested party has three total units [NOUs] and discounts each unit $120.00 per month for one month, DOD is 1 [the number of months discounted] factored by the Base Factor 12 rendering an RDA of $10.00 per unit for a total RDA for all units of $30.00 [discount of $120.00×(1{number of months being discounted}÷12{Base Factor [BF]})=$10.00]. Each unit has an RDA of $10.00 and total RDA of all units of this interested party is $30.00. In short, each unit RDA=its unit TDA×[DOD÷BF]. All unit RDAs combine and substitute for TDA in FIG. 2.

If the monthly cost per unit is $1,200.00, the RCA is established as follows: DOD is 1 for the number of months the respective unit is being discounted. Since the Base Factor is 12, the yearly total cost of that unit, or RCA, is $14,400.00 [monthly cost of $1,200.00÷(1{number of months being discounted}÷12 {Base Factor})=$14,400.00]. In short, each unit RCA=its unit TCA÷[DOD÷BF]. All unit RCAs combine and substitute for TCA in FIG. 2.

Some examples illustrative of this ranking approach are set forth below in rental examples with the base factor being 12 representing one year in 12 monthly increments.

### Interested Party A:

### Unit 1

Monthly cost=$1,000.00
Discount per month=$100.00
DOD=2 months with base factor 12
Unit 1 TDA=$200.00
   Unit 1 RDA=DOD÷Base Factor×Unit 1 TDA [2/12×Unit 1 TDA]=$33.33
Unit 1 TCA=$2,000.00
   Unit 1 RCA=12/2×Unit 1 TCA=$12,000.00

### Unit 2

Monthly cost=$1,100.00
Discount per month=$110.00
DOD=3 months with base factor 12
Unit 2 TDA=$330.00
   Unit 2 RDA=3/12×Unit 2 TDA=$82.50
Unit 2 TCA=$3,300.00
   Unit 2 RCA=12/3×Unit 2 TCA=$13,200.00

### Unit 3

Monthly cost=$1,200.00
Discount per month=$120.00
DOD=1 months with base factor 12
Unit 3 TDA=$120.00
   Unit 3 RDA=1/12×Unit 3 TDA=$10.00
Unit 3 TCA=$1,200.00
   Unit 3 RCA=12/1×Unit 3 TCA=$14,400.00

### Therefore for Interested Party A:

A [NOD=3]÷B [NOU=3]=1.000=X; and

### Either:

Option RDA
C [All RDA=$125.83]÷D [All TCA=$6,500.00]=0.019=Y;
X+Y=1.019=Z=SER
(X+Y)×E [where E=100]=101.9=SER
(X+Y)×E [where E=10]=10.19=SER
   or

Option RCA
C [All TDA=$650.00]÷D [All RCA=$39,600]=0.016=Y
X+Y=1.016=Z=SER
(X+Y)×E [where E=100]=101.6=SER
(X+Y)×E [where E=10]=10.16=SER

### Interested Party B:

### Unit 1

Monthly cost=$1,000.00
Discount per month=$100.00
DOD=12 months with base factor 12
Unit 1 TDA=$1,200.00
   Unit 1 RDA=12/12×Unit 1 TDA=$1,200.00
TCA=$12,000.00
   Unit 1 RCA=12/12×Unit 1 TCA=$12,000.00

### Unit 2

Monthly cost=$1,100.00
Discount per month=$110.00
DOD=12 months with base factor 12
Unit 2 TDA=$1,320.00
   Unit 2 RDA=12/12×Unit 2 TDA=$1,320.00
Unit 2 TCA=$13,200.00
   Unit 2 RCA=12/12×Unit 2 TCA=$13,200.00

### Unit 3

Monthly cost=$1,200.00
Discount per month=$120.00
DOD=12 months with base factor 12
Unit 3 TDA=$1,440.00
   Unit 3 RDA=12/12×Unit 3 TDA=$1,440.00
Unit 3 TCA=$14,400.00
   Unit 3 RCA=12/12×Unit 3 TCA=$14,400.00

### Therefore for Interested Party B:

A [NOD=3]÷B [NOU=3]=1.000=X; and

### Either:

Option RDA
C [All RDA=$3,960.00]÷D [All TCA=$39,600.00]=0.10=Y;
X+Y=1.10=Z=SER
(X+Y)×E [where E=100]=110.0=SER
(X+Y)×E [where E=10]=11.00=SER
   or

Option RCA
C [All TDA=$3,960.00]÷D [All RCA=$39,600]=0.10=Y
X+Y=1.10=Z=SER
(X+Y)×E [where E=100]=110.0=SER
(X+Y)×E [where E=10]=11.00=SER

### Interested Party C:

### Unit 1

Monthly cost=$1,000.00
Discount per month=$100.00
DOD=4 months with base factor 12
Unit 1 TDA=$400.00
   Unit 1 RDA=4/12×Unit 1 TDA=$133.33
Unit 1 TCA=$4,000.00
   Unit 1 RCA=12/4×Unit 1 TCA=$12,000.00

### Unit 2

Monthly cost=$1,100.00
Discount per month=$110.00
DOD=6 months with base factor 12
Unit 2 TDA=$660.00
   Unit 2 RDA=6/12×Unit 2 TDA=$330.00
Unit 2 TCA=$6,600.00
   Unit 2 RCA=12/6×Unit 2 TCA=$13,200.00

### Unit 3

Monthly cost=$1,200.00
Discount per month=$120.00
DOD=2 months with base factor 12
Unit 3 TDA=$240.00
   Unit 3 RDA=2/12×Unit 3 TDA=$40.00
Unit 3 TCA=$2,400.00
   Unit 3 RCA=12/2×Unit 3 TCA=$14,400.00

### Therefore for Interested Party C

A [NOD=3]÷B [NOU=3]=1.000=X; and

### Either:

Option RDA
C [All RDA=$503.33]÷D [All TCA=$13,000.00]=0.039=Y;
X+Y=1.039=Z=SER
(X+Y)×E [where E=100]=103.9=SER
(X+Y)×E [where E=10]=10.39=SER
   or

Option RCA
C [All TDA=$1,300.00]÷D [All RCA=$39,600]=0.032=Y
X+Y=1.033=Z=SER
(X+Y)×E [where E=100]=103.3=SER
(X+Y)×E [where E=10]=10.33=SER

### Interested Party D:

### Unit 1

Monthly cost=$1,000.00
Discount per month=$100.00
DOD=4 months with base factor 12
Unit 1 TDA=$400.00
   Unit 1 RDA=4/12×Unit 1 TDA=$133.33
Unit 1 TCA=$4,000.00
   Unit 1 RCA=12/4×Unit 1 TCA=$12,000.00

### Unit 2

Monthly cost=$1,100.00
Discount per month=$110.00
DOD=2 months with base factor 12
Unit 2 TDA=$220.00
   Unit 2 RDA=2/12×Unit 2 TDA=$36.67
Unit 2 TCA=$2,200.00
   Unit 2 RCA=12/2×Unit 2 TCA=$13,200.00

### Unit 3

Monthly cost=$1,200.00
Discount per month=$0.00
DOD=0 months with base factor 12
Unit 3 TDA=$0.00
   Unit 3 RDA=1/12×Unit 3 TDA=$0.00
TCA=$1,200.00
   Unit 3 RCA=12/1×Unit 3 TCA=$14,400.00

### Therefore for Interested Party D:

A [NOD=2]÷B [NOU=3]=0.667=X; and

### Either:

Option RDA
C [All RDA=$170.00]÷D [All TCA=$7,400.00]=0.023=Y;
X+Y=0.690=Z=SER
(X+Y)×E [where E=100]=69.0=SER
(X+Y)×E [where E=10]=6.90=SER
   or

Option RCA
C [All TDA=$620.00]÷D [All RCA=$39,600]=0.016=Y
X+Y=0.690=Z=SER
(X+Y)×E [where E=100]=69.0=SER
(X+Y)×E [where E=10]=6.90=SER

DOD also may be determined by the longest duration provided by an interested party. That DOD [the longest duration] will be the Base Factor [BF] For the DOD applied to other interested parties. For example, if unit 1 is being discounted for 6 months whereas unit 2 is being discounted for 3 months, total DOD, and Base Factor [BF] for both units could be 6 months. As another example, if unit 1 has a discount offered for only one week and unit 2 has a discount offered for 3 months, the Base Factor will be determined upon how many weeks are in 3 months. If the months involved are March through May, total days for March through May is 92. The Base Factor will be 13.14 [total days of 92 divided by total days of discount for unit 1 which is 7 leaving a quotient of 13.14]. If the months involved are February through April, total days for February through April, excluding leap years, is 89. The Base Factor will be 12.71 [total days of 89 divided by total days of discount for unit 1 which is 7 leaving a quotient of 12.71].

As a final example, if unit 1 has a discount offered for only one week and unit 2 has a discount offered for 1 year, the Base Factor will be determined upon the total number of weeks in a year. In this regard, the Base Factor will be 52.00 [total number of weeks in a year of 52 divided by total number of weeks for which a discount is offered for unit 1 which is 1 leaving a quotient of 52.00].

The present disclosure includes that contained in the present claims as well as that of the foregoing description. Although this search engine ranking [SER] of this disclosure has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the search engine ranking [SER] of this disclosure. Accordingly, the scope of the search engine ranking [SER] of this disclosure should be determined not by the embodiment[s] illustrated, but by the appended claims and their legal equivalents.

Applicant has attempted to disclose all the embodiments of the search engine ranking [SER] of this disclosure that could be reasonably foreseen. It must be understood, however, that there may be unforeseeable insubstantial modifications to search engine ranking [SER] of this disclosure that remain as equivalents and thereby falling within the scope of the search engine ranking [SER] of this disclosure.

What is claimed is:

1. A ranking system comprising:
(a) data input means for receiving data from an interested party wherein said data comprises said interested party's total number of units combined (NOU), of said total number of units combined (NOU) a total number of discounted units (NOD) offered by said interested party, total combined costs for said total number of units combined (NOU) defining a total combined cost amount (TCA), and total combined discount amounts for said total number of discounted units (NOD) defining a total combined discount amount (TDA);
(b) data storage means for storing said data received from each of said interested party and identifying said data unique to each one of said interested party;
(c) data processing means for processing said data to yield a search-engine ranking (SER) unique to each one of said interested party and providing said search-engine ranking (SER) in a pre-determined order to an end user pursuant to a request from said end user; and
(d) search request means for receiving said request from said end user and conveying said search-engine ranking (SER) to said end user.

2. The system of claim 1 wherein said search-engine ranking (SER) comprises a combination of a first component (X), wherein said first component (X) is a ratio between said interested party's total number of discounted units (NOD) and said interested party's total number of units combined (NOU), with a second component (Y), wherein said second component (Y) is a ratio between said total combined discount amount (TDA) of said interested party and said total combined cost amount (TCA) of said interested party.

3. The system of claim 2 wherein said total number of discounted units (NOD) further comprises a duration of discount (DOD) for each one of said total number of discounted units (NOD) wherein a longest of said duration of discount (DOD) defines a standard base factor (BF) for each one of said total number of discounted units (NOD) and wherein a relative discount amount (RDA) is established as a product from a ratio between said duration of discount (DOD) and said base factor (BF) as applied to said total combined discount amount (TDA).

4. The system of claim 3 wherein a duration for said duration of discount (DOD) is a value greater than zero or less than zero.

5. The system of claim 2 wherein said total combined cost amount (TCA) further comprises a duration of discount (DOD) for said total combined cost amount (TCA) wherein a longest of said duration of discount (DOD) defines a standard base factor (BF) for said total combined cost amount (TCA) and wherein a relative cost amount (RCA) is established as a quotient from a ratio between said duration of discount (DOD) and said base factor (BF) as applied to said total combined cost amount (TCA).

6. The system of claim 5 wherein a duration for said duration of discount (DOD) is a value greater than zero or less than zero.

7. The system of claim 2 wherein said search-engine ranking (SER) further comprises a standard pre-determined value factor to be applied to said search-engine ranking (SER).

8. The system of claim 7 wherein said value factor is a value greater than zero.

9. A method of establishing ranking comprising:
(a) receiving data from an interested party wherein said data comprises said interested party's total number of units combined (NOU), of said total number of units combined (NOU) a total number of discounted units (NOD) offered by said interested party, total combined costs for said total number of units combined (NOU) defining a total combined cost amount (TCA), and total combined discount amounts for said total number of discounted units (NOD) defining a total combined discount amount (TDA);
(b) storing said data received from each of said interested party and identifying said data unique to each said interested party; and
(c) processing said data to yield a search-engine ranking (SER) unique to each of said interested party and providing said search-engine ranking (SER) in a pre-determined order to an end user pursuant to a request from said end user.

10. The method of claim 9 wherein said search-engine ranking (SER) comprises combining a first component (X) with a second component (Y), wherein said first component (X) is a ratio between said interested party's total number of discounted units (NOD) and said interested party's total number of units combined (NOU), and wherein said second component (Y) is a ratio between said total combined discount amount (TDA) of said interested party and said total combined cost amount (TCA) of said interested party.

11. The method of claim 10 wherein said total number of discounted units (NOD) further comprises ascertaining a duration of discount (DOD) for each one of said total number of discounted units (NOD) wherein a longest of said duration of discount (DOD) defines a standard base factor (BF) for each one of said total number of discounted units (NOD), and establishing a relative discount amount (RDA) as a product from a ratio between said duration of discount (DOD) and said base factor (BF) as applied to said total combined discount amount (TDA).

12. The system of claim 11 wherein a duration for said duration of discount (DOD) is a value greater than zero or less than zero.

13. The method of claim 10 wherein said total combined cost amount (TCA) further comprises ascertaining a duration of discount (DOD) for said total combined cost amount (TCA) wherein a longest of said duration of discount (DOD) defines a standard base factor (BF) for said total combined cost amount (TCA), and establishing a relative cost amount (RCA) as a quotient from a ratio between said duration of discount (DOD) and said base factor (BF) as applied to said total combined cost amount (TCA).

14. The system of claim 13 wherein a duration for said duration of discount (DOD) is a value greater than zero or less than zero.

15. The system of claim 10 wherein said search-engine ranking (SER) further comprises applying a standard pre-determined value factor said search-engine ranking (SER).

16. The system of claim 15 wherein said value factor is a value greater than zero.
